(19) United States
(12) Patent Application Publication
(10) Pub. No.: US 2003/0071511 A1
(43) Pub. Date: Apr. 17, 2003

(54) Belt tensioning mechanism

(76) Inventors: Daniel G. Stafford, Richmond, IN (US); Herman J. Shie III, Union, OH (US); Jeffery A. Barger, Greenville, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 09/975,459

(22) Filed: Oct. 11, 2001

(51) Int. Cl. B60R 22/10

(52) U.S. Cl. 297/484

(57) ABSTRACT

A car seat including a seat body having a seat back and a seat pan for supporting an occupant thereon, and at least one belt coupled to the seat body for retaining an occupant on the seat body. The car seat further includes a belt tensioning mechanism, the belt tensioning mechanism including a pawl coupled to the seat body and a rotatable spool coupled to the belt. The spool can be rotated to wind the belt upon the spool, and the spool includes a gear that can interact with the pawl such that the pawl can selectively block rotation of the spool and thereby block unwinding of the belt off of the spool.

The present invention is directed to a belt tensioning mechanism, and more particularly, to a belt tensioning mechanism for use in a car seat.

### BACKGROUND OF THE INVENTION

Car seats are widely used to secure children or infants in a vehicle. Such car seats are typically secured to the vehicle by one or more vehicle belts (i.e. by a two or three point belt). The car seat may include a harness to secure the occupant in the car seat. The tension or size of the harness may be adjustable to accommodate entry and exit of the child into and from the car seat, and to accommodate differently-sized occupants or growth of the occupant.

### SUMMARY OF THE INVENTION

The present invention is a car seat having a belt tensioning mechanism. The car seat includes at least one belt that is coupled to a spool which can be rotated to wind the belt about the spool and thereby tension the belt. In one embodiment, the invention is a car seat including a seat body having a seat back and a seat pan for supporting an occupant thereon, and at least one belt coupled to the seat body for retaining an occupant on the seat body. The car seat further includes a belt tensioning mechanism, the belt tensioning mechanism including a pawl coupled to the seat body and a rotatable spool coupled to the belt. The spool can be rotated to wind the belt upon the spool, and the spool includes a gear that can interact with the pawl such that the pawl can selectively block rotation of the spool and thereby block unwinding of the belt off of the spool. In one embodiment, the spool extends transversely across the width of the car seat to provide convenient access to the spool.

Other objects and advantages of the present invention will be apparent from the following description and the accompanying drawings.

### BRIEF DESCRIPTION OF THE DRAWINGS

FIG. 1 is a front perspective view of one embodiment of the car seat of the present invention, illustrating the shoulder harnesses belts latched into the buckle;

FIG. 2 is a front perspective view of the car seat of FIG. 1, illustrating the shoulder harnesses unlatched from the buckle;

FIG. 3 is a perspective view of a spool of one embodiment of the belt tensioning mechanism of the present invention;

FIG. 4 is a perspective view of a release lever of one embodiment of the belt tensioning mechanism of the present invention;

FIG. 5 is a front perspective view of one embodiment of the belt tensioning mechanism of the present invention in its engaged position;

FIG. 6 is a perspective view of the belt tensioning mechanism of FIG. 5, shown in its disengaged position;

FIG. 7 is a rear perspective view of the belt tensioning mechanism of FIG. 5 illustrating a set of belts attached thereto;

FIG. 8 is a detail view of one of the take-up reels of the belt tensioning mechanism of FIG. 7;

FIG. 9 is rear perspective view of the belt tensioning mechanism of FIG. 7, illustrating the belts spooled thereon;

FIG. 10 is a section taken along line 10-10 of FIG. 9; and

FIG. 11 is a bottom view of the car seat of FIGS. 1 and 2 illustrating the belt tensioning mechanism of FIGS. 5-9.

### DETAILED DESCRIPTION

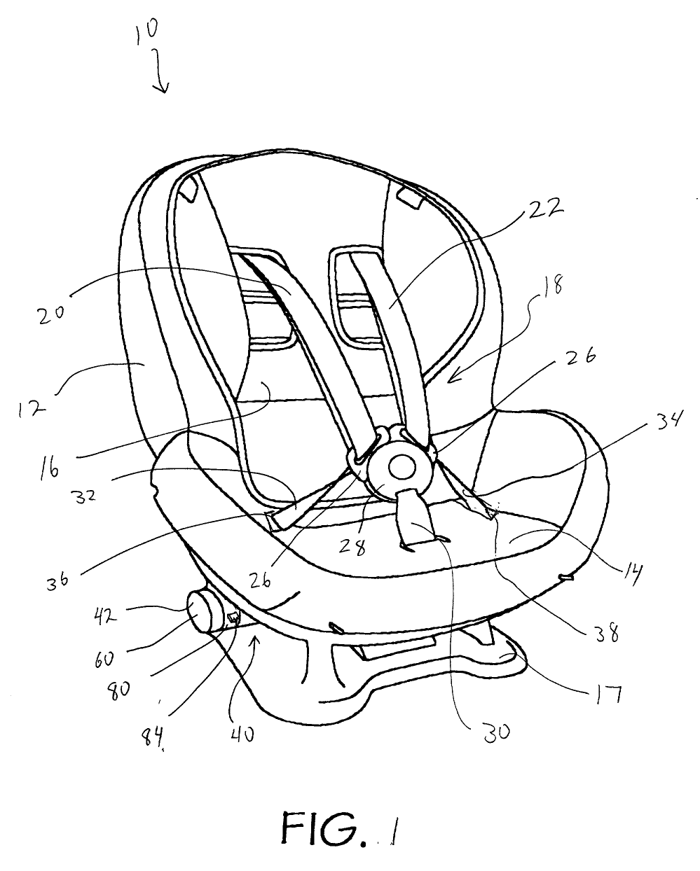

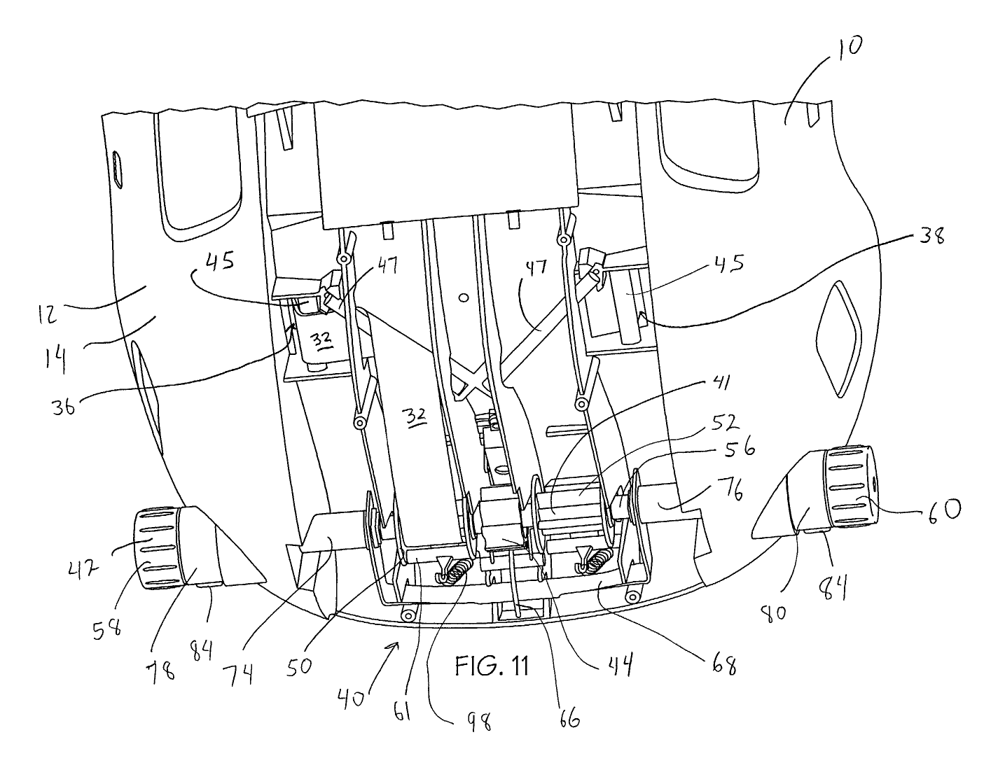

As shown in FIG. 1, the present invention includes a car seat 10 having a seat body 12 including a seat pan 14, a seat back 16 for supporting an occupant such as a child or infant, and a base 17. The car seat 10 includes a harness or restraint system 18 including a pair of shoulder harnesses 20, 22 shaped and located to fit over the shoulder of an occupant of the car seat. In the illustrated embodiment, one end of each shoulder harness 20, 22 is looped through the seat back 16 and the other end is looped around a tongue 26. Each tongue 26 is releasably receivable in a buckle 28, and the buckle 28 is coupled to the seat pan 14 by a buckle belt 30. The restraint system 18 further includes a pair of lap belts 32, 34, each lap belt 32, 34 being coupled to one of the tongues 26 to form a standard five point harness system. Each of the lap belts 32, 34 and one of the shoulder harnesses 20, 22 may be made from a single strap of material (i.e., the lap belt 32 and shoulder harness 20 may be a single strap of material, and the lap belt 34 and shoulder harness 22) may be formed from another strap of material. Alternately, each of the shoulder harnesses 20, 22 and lap belts 32, 34 may be made from different straps or pieces of material (i.e., for a total of four straps). In the illustrated embodiment, each lap belt 32, 34 extends through a slot 36, 38 in the seat pan 14 and is coupled to a belt tensioning mechanism 40 that is coupled to the base 17 and located below the seat pan 14 (see FIG. 11).

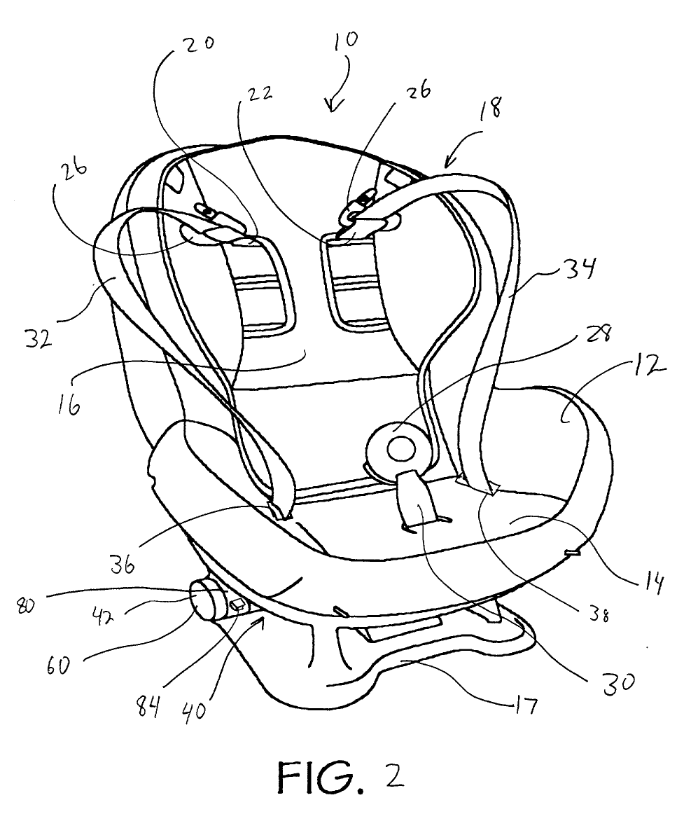

Although FIGS. 1 and 2 illustrate one type of car seat and harness mechanism, it should be understood that the belt tensioning mechanism 40 of the present invention may be used with nearly any car seat, regardless of the type of car seat or arrangement of the harness system. For example, although in the illustrated embodiment the lap belts 32, 34 are shown as extending through the slots 36, 38, the belt tensioning mechanism 40 may instead be coupled directly to the shoulder harnesses 20, 22 to tension the shoulder harnesses. For example, the shoulder harnesses 20, 22 may be slidably passed through openings in the seat back 16, extend along the back side of the seat back 16 and below the seat pan 14 to the belt tensioning mechanism 40 in a well known manner.

The belt tensioning mechanism 40 is shown in greater detail in FIG. 11. Each of the belts 32, 34 extends through one of the slots 36, 38 in the seat pan 14, and extends around a guide pin 45 at about a 90° angle (for ease of illustration only belt 32 is shown in FIG. 11). Thus, the guide pins 45 transition the generally vertically-extending portions of the belts 32, 34 to a generally horizontally-extending portion. The car seat 10 further includes a pair of angled bars 47 that preferably form about a 45° angle with the belts 32, 34. The belts 32, 34 are partially wrapped around the angled bars 47 to change the direction of the belts from left-to-right (i.e., across the width of the car seat) to front-to-back (i.e., along the depth of the car seat 10). The belts 32, 34 then extend to the belt tensioning mechanism 40.

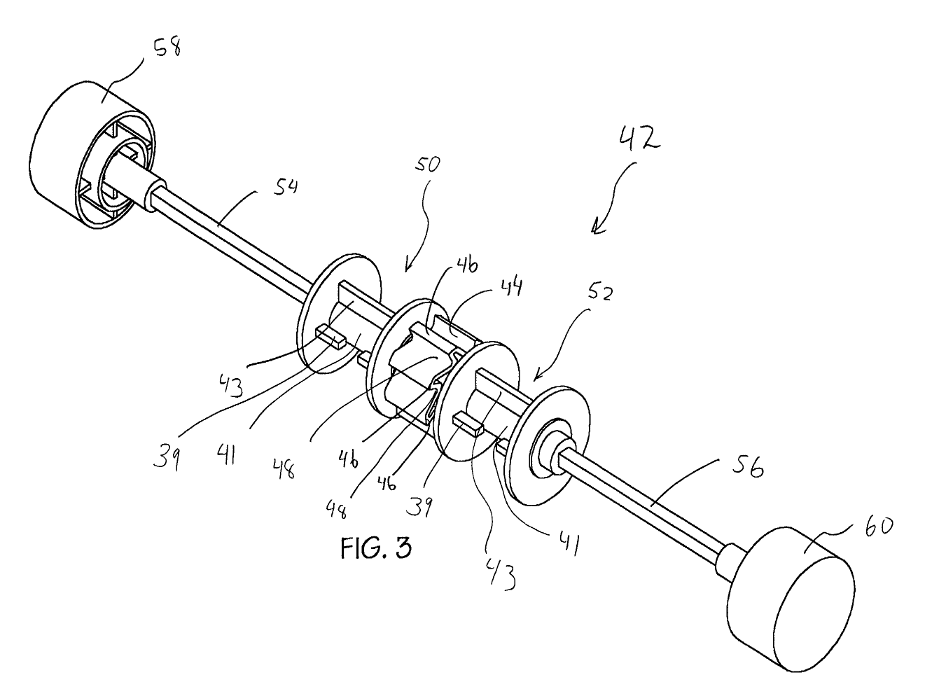

As shown in FIG. 3, the belt tensioning mechanism 40 includes a rotatable spool 42 which includes a central gear 44 having a plurality of teeth 46 defining a plurality of recesses 48 therebetween. The spool 42 further includes a pair of take-up reels 50, 52 located on either side of the gear 44, a pair of gripping portions or knobs 58, 60 located at the outer ends of the spool 42, and a pair of arms 54, 56 extending between one of the take-up reels 50, 52 and one of the knobs 58, 60. Each spool 50, 52 includes a central core 41, a pair of protruding bars 43 located on the core 41 and a pair of tabs 39 located on the core 41.

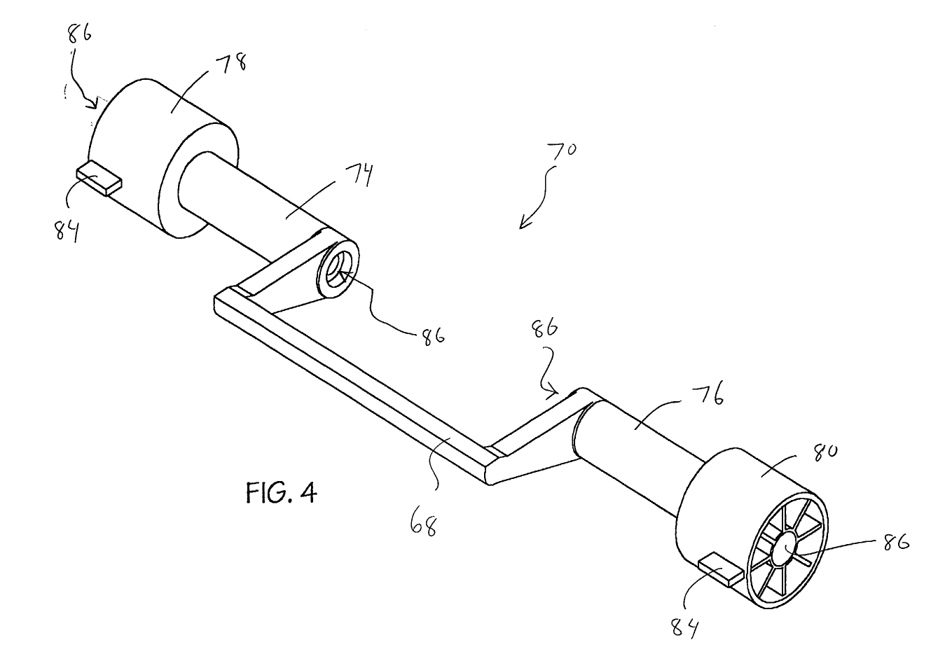

The belt tensioning mechanism 40 includes a release lever 70 as shown in FIG. 4. The release lever 70 includes a crossbar 68 and a pair of outer gripping portions 78, 80 located on the outer ends of the release lever 70. Each gripping portion 78, 80 has a flange 84 located thereon. The release lever 70 includes a pair of connecting portions 74, 76 extending between the cross bar 68 and the gripping portions 78, 80. The release lever 70 has a central hole 86 extending along the central axis of the release lever 70.

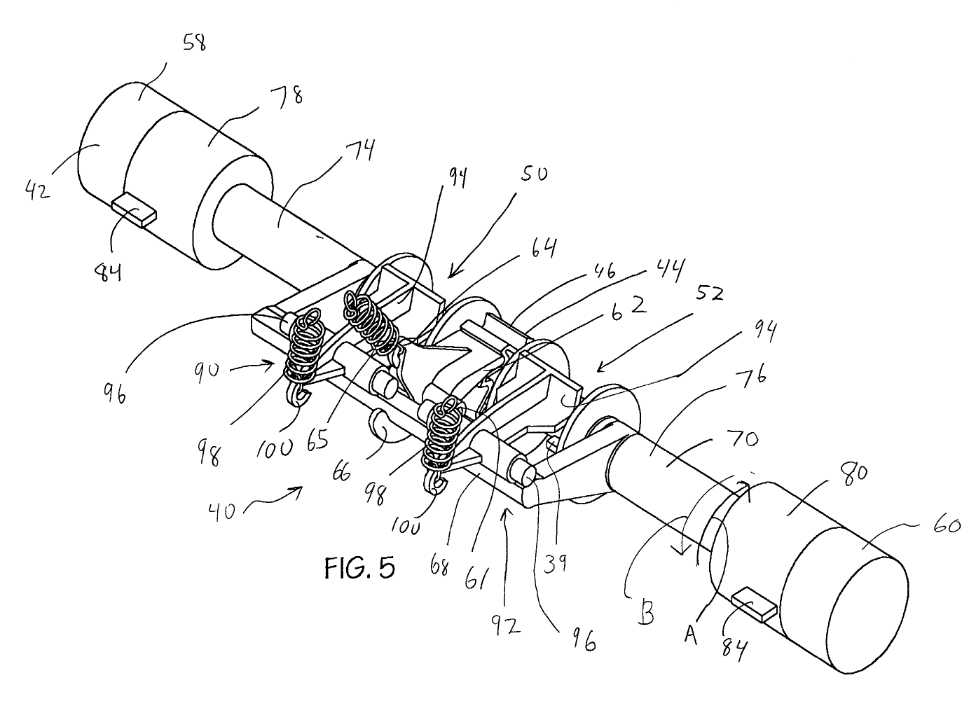

FIG. 5 illustrates the spool 42 of FIG. 3 coupled to the release lever 70 of FIG. 4. In particular, the spool 42 is coaxial with the release lever 70 of FIG. 4, and the arms 54, 56 of the spool 42 are received in the central hole 86 of the connecting portions 74, 76 of the release lever 70. The belt tensioning mechanism 40 includes a pawl 62 that is spring biased into engagement with the gear 44. The pawl 62 is rotatable about a pawl shaft 61 and includes an upper hook portion 64 which receives a spring 65 thereon to spring bias the pawl 62 into engagement with the gear 44. The upper end of the spring 65 may be coupled to the lower surface of the seat pan 14. The pawl 62 includes a lower hook portion 66 which receives the crossbar 68 of a release lever 70 therein.

In the configuration shown in FIG. 5, the pawl 62 and belt tensioning mechanism 40 are in their engaged positions wherein the pawl 62 is received in one of the recesses 48 (i.e., between a pair of teeth 46) of the central gear 44. The pawl 62 and the teeth 46 of the gear 44 are shaped and angled such that the pawl 62 can ride along the teeth 46 when the gear 44 is rotated in direction A (the spooling direction). However, when the gear 44 is attempted to be rotated in direction B (the unspooling direction) and the pawl 62 is in its engaged position, the pawl 62 is received in one of the recesses 48, and the gear 44 is blocked from rotating in the unspooling direction B.

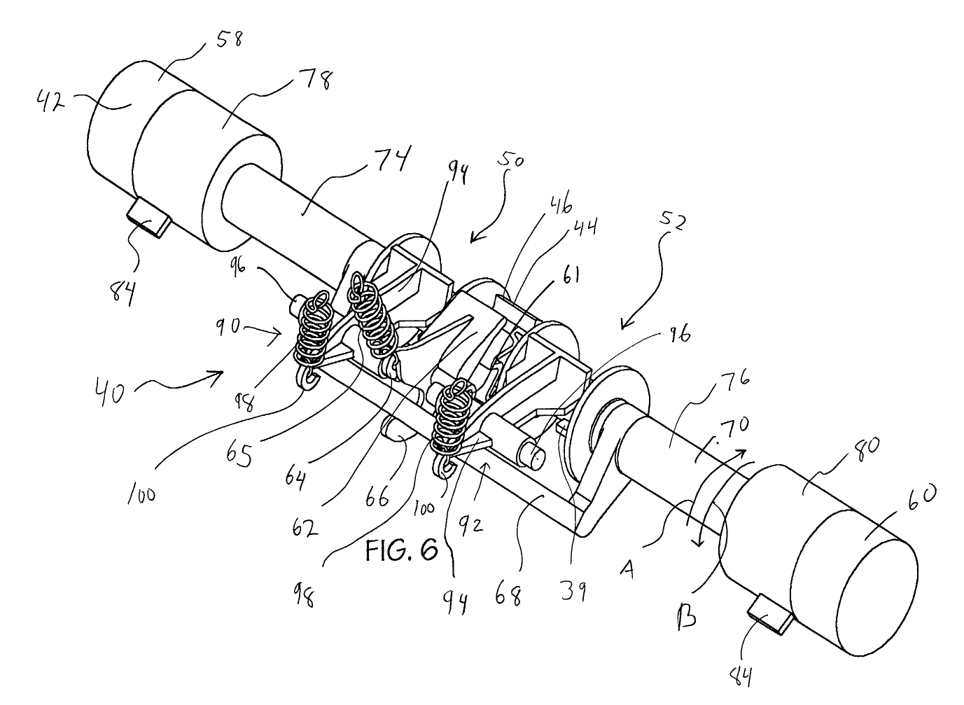

In order to move the belt tensioning mechanism 40 from its engaged position to its disengaged position, the release lever 70 is rotated in the unspooling direction B. The flanges 84 and/or the gripping portions 78, 80 provide a surface that can be gripped by a user to rotate the release lever 70 in the unspooling direction B. When the release lever 70 is rotated in the unspooling direction B, the crossbar 68 engages the lower hook portion 66 of the pawl 62 and pivots the pawl 62 about its pawl shaft 61, thereby tensioning the spring 65. Once the release lever 70, crossbar 68 and pawl 62 are sufficiently rotated, the pawl 62 is pulled out of engagement with the gear 44, as shown in FIG. 6. When in its disengaged position, the pawl 62 does not block rotation of the gear 44 in the unspooling direction B. In this manner, the pawl 62 is movable between an engaged position (FIG. 5) wherein the pawl 62 engages the gear 44 and can interact with the gear 44 to selectively block rotation of the spool 42, and the disengaged position (FIG. 6) wherein the pawl 62 does not contact the gear 44 and does not block rotation of the spool 42. When the release lever 70 is released by the user, the pawl 62 returns to its engaged position, as biased by the spring 65.

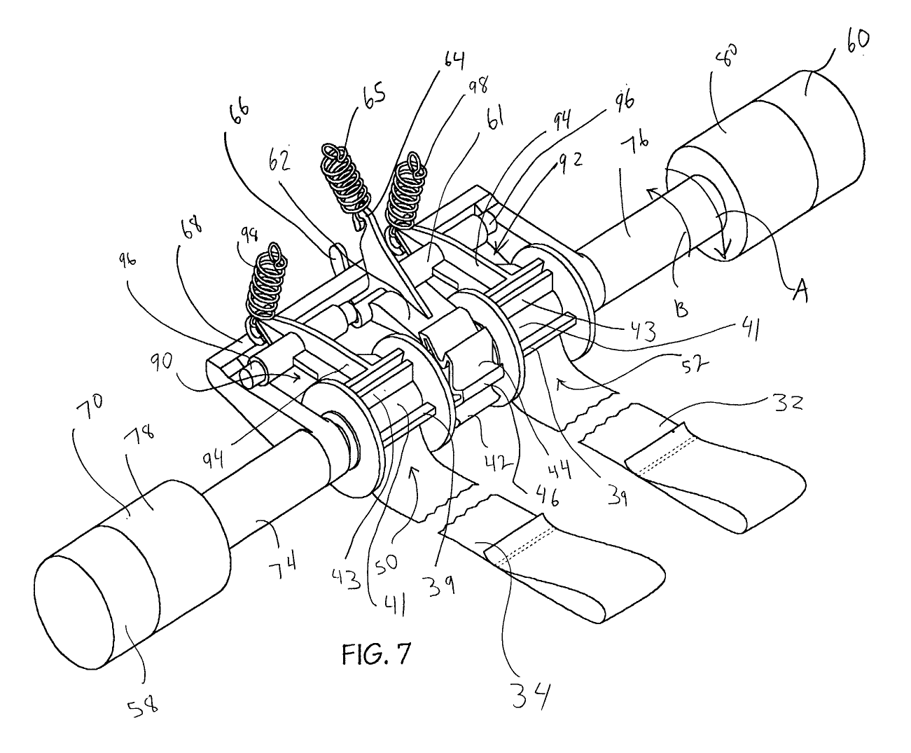

FIG. 7 illustrates the tensioning mechanism of FIGS. 5 and 6, with the lap belts 32, 34 coupled thereto. Each of the lap belts 32, 34 is coupled to one of the take-up reels 50, 52, such as by directly attaching one end of the belts 32, 34 to the take-up reels 50, 52. FIG. 7 illustrates the belts 32, 34 in their completely unspooled condition, and the harness 18 is preferably configured so that it is loose or slack in this condition. In order to spool the belts 32, 34 about the belt tensioning mechanism 40 and add tension to the harness 18, the spool 42 is rotated in the spooling direction A, such as by gripping and rotating the gripping portions 58, 60 of the spool 42 in the spooling direction.

As the take-up reels 50, 52 of the spool 42 are rotated in the spooling direction A, the belts 32, 34 are wound about the take-up reels 50, 52. Furthermore, the pawl 62 rides along the teeth 46 of the gear 44 to permit rotation of the spool 42 in the spooling direction A and block rotation of the spool 42 in the unspooling direction B. In this manner, the belts 32, 34 can be wound about the spool 42 to tighten the belts 32, 34. Furthermore, as noted above, when in its engaged position, the belt tensioning mechanism 40 prevents the spool 42 from rotating in the unspooling direction B, which thereby prevents the belts 32, 34 from being unspooled from the take-up reels 50, 52. In this manner, one or both of the knobs 58, 60 can be rotated to add tension to the harness system 18 through a ratchet mechanism. Thus, the procedure described above can be used to tighten down the harness 18 and secure an occupant in the car seat 10.

When it is desired to unspool the belts 32, 34 from the take-up reels 50, 52, the release lever 70 is rotated in the unspooling direction B, such as by gripping and rotating the flanges 84 as described earlier, to move the pawl 62 to its disengaged position as shown in FIG. 6. When the belt tensioning mechanism 40 is located in this position, the belts 32, 34 can be freely unspooled off of the spool 42, such as by simply pulling upon the belts 32, 34. Upon release of the release lever 70 the pawl 62 returns to its engaged position. In this manner, the tension in the harness 18 can be reduced, or the effective size of the harness increased, to accommodate larger-sized occupants or to enable the occupant to exit the car seat 10.

As shown in FIG. 7, the tensioning mechanism 40 includes a pair of blocking mechanisms generally designated 90, 92. Each blocking mechanism 90, 92 includes an arm 94 having an upwardly-extending end lip 93 that is received in an associated take-up reel 50, 52 and is pivotable about an arm rod 96. The arms 94 are each biased into engagement with one of the take-up reels 50, 52 by a spring 98 received around a hook portion 100 of the arms 94. The upper end of each spring 98 may be coupled to the underside of the seat pan 14.

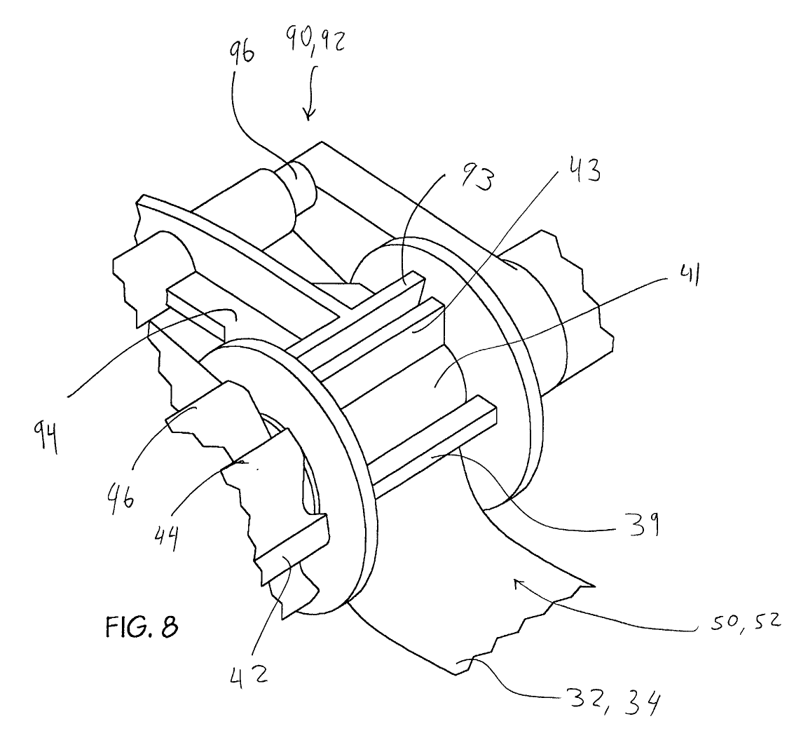

Each blocking mechanism 90, 92 further includes the bars 43 of the take-up reels 50, 52. When the belts 32, 34 are in their completely unspooled condition, the bars 43 of the take-up reels 50, 52 are located adjacent to the end lips 93 of the arms 94, as shown in FIGS. 7 and 8. In other words, the arms 94 and spools 50, 52 are shaped such that the arms 94 are located adjacent to the bars 43 when the belts 32, 34 are fully unspooled off the take-up reels 50, 52. In this manner, the bars 43 and arms 94 cooperate to form the blocking mechanisms 90, 92 which prevent undesired rotation of the spool 42 in the unspooling direction B. For example, if the pawl 62 in FIG. 7 were moved to its disengaged position, and the spool 42 were attempted to be rotated in the unspooling direction B, the bars 43 would engage the ends of the arms 94 and thereby prevent rotation of the take-up reels 50, 52 in the unspooling direction B. Thus, the blocking mechanisms 90, 92 prevent spooling of the belts 32, 34 upon the take-up reels 50, 52 in the wrong direction.

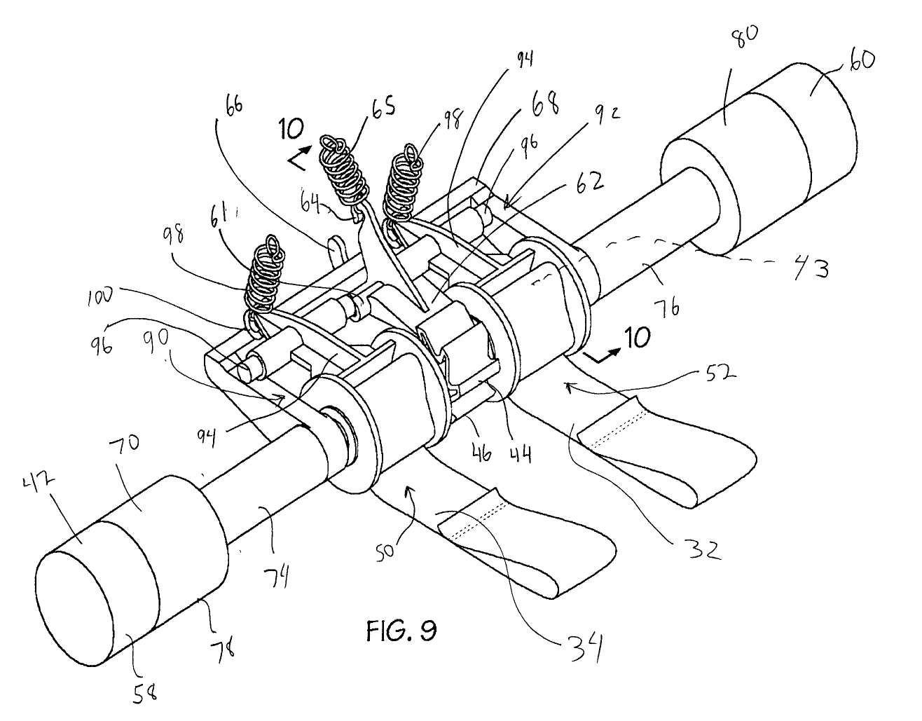

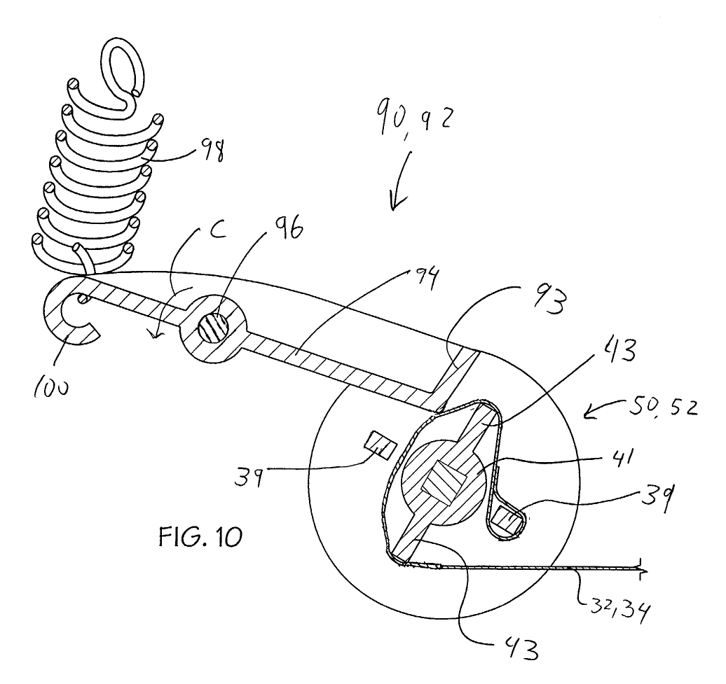

As shown in FIGS. 9 and 10, once the belts 32, 34 are wound around the take-up reels 50, 52 at least one time (i.e., after at least one revolution of the take-up reels 50, 52 or after one layer of belts 32, 34 is located on the reels 50, 52), the belts 32, 34 cover the bars 43 of the take-up reels 50, 52. In this manner, once the belts 32, 34 are wound at least one time about the take-up reels 50, 52, the arms 94 rest upon the top surface of the belts 32, 34, and the arms 94 are pivoted slightly about their arm rods 96 in the direction of arrow C to their position in FIGS. 9 and 10. In other words, the arms 94 are pivoted upwardly and do not engage the bars 43 in the configuration of FIGS. 9 and 10 due to the presence of the belts 32, 34. In this manner, the blocking mechanisms 90, 92 do not prevent the belts 32, 34 from being unspooled when the pawl 62 is moved to its disengaged position and a user pulls on the belts 32, 34. The arms 94 are spring biased into engagement with the take-up reels 50, 52 by the springs 98 such that the arms 94 return to their positions shown in FIG. 7 when the belts 32, 34 are unspooled off of the spool 42. Finally, the arms 94 and bars 43 are shaped such that the arms 94 do not block rotation of the spool 42 in the spooling direction A.

The locations of the gear 44 and the pawl 62 can be reversed such that the gear 44 is located on the seat body 12 and the pawl 62 is located on the spool 42. In this case, the pawl 62 may be resiliently or spring mounted to the spool 42, and the gear 44 may include a plurality of inwardly extending teeth such that the pawl 62 can rotate along with the spool 42 in a ratcheting manner. As shown in FIGS. 1 and 2, the central axes of the belt tensioning mechanism 40, spool 42 and release lever 70 extend generally transversely below the width of the seat pan 14. In this manner, the gripping portions 58, 60, 78, 80 protrude outwardly from the sides of the car seat 10. This arrangement of the belt tensioning mechanism provides gripping portions located on either side of the car seat 10, which provides two points of access for operating the belt tensioning mechanism 40. Furthermore, because the gripping portions 58, 60, 78, 80 are located on the sides of the car seat 10, the gripping portions 58, 60, 78, 80 are conveniently located. For example, when the car seat 10 is located in a vehicle, one set of the gripping portions 58, 60, 78, 80 will be located adjacent to an open car door or to an adjacent occupant of the car. Furthermore, in one embodiment the slots 36, 38 in the seat pan 14 enable the lap belts 32, 34 to pass through the seat pan 14 and be directly coupled to the belt tensioning mechanism 40. In this manner, the lap belts 32, 34, and not the shoulder harnesses 20, 22, are coupled to the belt tensioning mechanism 40. This arrangement reduces the extra length of the shoulder belts and connection equipment in many existing car seats that is required to connect the shoulder belts 20, 22 to the belt tensioning mechanism.

Having described the invention in detail and by reference to the preferred embodiments, it will be apparent that modifications and variations thereof are possible without departing from the scope of the invention.

What is claimed is:

1. A car seat comprising:
a seat body including a seat back and a seat pan for supporting an occupant thereon;
at least one belt coupled to said seat body for retaining an occupant on said seat body; and
a belt tensioning mechanism, said belt tensioning mechanism including a pawl coupled to said seat body and a rotatable spool coupled to said belt such that said spool can be rotated to wind said belt upon said spool, said spool including a gear that can interact with said pawl such that said pawl can selectively block rotation of said spool and thereby block unwinding of said belt off of said spool.

2. The car seat of claim 1 wherein said pawl is movable between an engaged position wherein said pawl contacts said gear and can interact with said gear to selectively block rotation of said spool, and a disengaged position wherein said pawl does not contact said gear.

3. The car seat of claim 2 wherein said spool can be rotated in a first direction to wind said belt upon said spool, and wherein said pawl can block rotation of said spool in a second direction opposite to said first direction when said pawl is in said engaged position.

4. The car seat of claim 3 wherein said gear includes a plurality of teeth and said pawl contacts at least one of said teeth when said pawl is in said engaged position, and wherein at least one of said pawl or said teeth are angled such that said pawl can ride along said teeth and enable said spool to rotate in said first direction and wherein at least one of said pawl or said teeth are angled such that said pawl is lockingly received between a pair of teeth when said spool is rotated in said second direction to thereby block rotation of said spool in a ratcheting action.

5. The car seat of claim 3 further comprising a blocking mechanism that prevents said spool from rotating in said second direction when said pawl is in said disengaged position.

6. The car seat of claim 5 wherein said blocking mechanism includes an arm coupled to said seat body and a bar coupled to said spool, said arm being shaped and located to engage said bar when said spool is attempted to be rotated in said second direction to prevent the rotation of said spool in said second direction.

7. The car seat of claim 6 wherein said ann is spring biased into engagement with said spool.

8. The car seat of claim 7 wherein said arm and said spool are shaped such that said arm is located adjacent to said bar when said belt is unspooled off of said spool.

9. The car seat of claim 2 wherein said pawl is spring biased into said engaged position.

10. The car seat of claim 2 further comprising a release lever, said release lever being activatable to move said pawl from said engaged position to said disengaged position.

11. The car seat of claim 10 wherein said release lever is rotatable to move said pawl from said engaged position to said disengaged position, and wherein said release lever includes a connection shaft that is generally coaxial with said spool.

12. The car seat of claim 11 wherein said spool includes at least one gripping portion and said release lever includes at least one gripping portion located at an end of said connection shaft and located adjacent to said gripping portion of said spool.

13. The car seat of claim 1 wherein said spool extends generally transversely underneath said set pan.

14. The car seat of claim 13 wherein said spool includes a pair of gripping portions, each gripping portion extending from opposite sides of said seat body.

15. The car seat of claim 1 wherein said spool is rotatable about an axis that extends generally parallel to a width of said car seat.

16. The car seat of claim 1 wherein said at least one belt includes a lap belt portion shaped and located to extend across the lap of an occupant and a shoulder harness portion shaped and located to extend across the torso of an occupant, and wherein said car seat further includes an auxiliary belt including a lap belt portion shaped and located to extend across the lap of an occupant and a shoulder harness portion shape and located to extend across the torso of an occupant, and wherein both said belt and said auxiliary belt are coupled to said belt tensioning mechanism.

17. The car seat of claim 16 wherein each lap belt portion extends through said seat pan and is coupled to said spool.

18. The car seat of claim 17 wherein said spool includes a pair of take-up reels, and wherein each lap belt portion is coupled to and spoolable about one of said take-up reels.

19. The car seat of claim 17 wherein said car seat includes a first set of bars coupled to said frame and located below said seat pan to guide said lap belt portions from a generally vertically-extending direction to a generally horizontally-extending direction.

20. The car seat of claim 19 wherein said car seat includes a second set of bars coupled to said frame and located below said seat pan to guide said lap belt portions from a generally width-wise direction to a generally depth-wise direction.

21. The car seat of claim 20 wherein each of said second set of bars forms about a 45 degree angle with the associated lap belt portions.

22. The car seat of claim 1 wherein said car seat is attachable to a vehicle seat.

23. A car seat comprising:
a seat body including a seat back and a seat pan for supporting an occupant thereon;
at least one belt coupled to said seat body for retaining an occupant on said seat body; and
a belt tensioning mechanism including a pawl, a gear and a rotatable spool coupled to said belt such that said spool can be rotated to wind said belt upon said spool, at least one of said pawl or said gear being coupled to said spool, the other of said pawl or said gear being coupled to said seat body such that said gear can interact with said pawl to selectively block rotation of said spool.

24. A car seat for a child or infant comprising:
a seat body including a seat back and a seat pan for supporting an occupant thereon;
at least one belt coupled to said seat body for retaining an occupant on said seat body; and
a belt tensioning mechanism including a rotatable spool extending generally transversely underneath said seat pan and being coupled to said belt such that said spool can be rotated in a first direction to wind said belt upon said spool, said spool including a toothed gear, said belt tensioning mechanism including a pawl that is movable between an engaged position wherein said pawl contacts said gear and can interact with said gear to selectively block rotation of said spool, and a disengaged position wherein said pawl does not contact said gear, wherein said pawl can block rotation of said spool in a second direction opposite to said first direction when said pawl is in said engaged position, said pawl being biased into said engaged position, said car seat including a release lever that is activatable to move said gear from said engaged position to said disengaged position.

25. A car seat for a child or infant comprising:
a seat body including a seat back and a seat pan for supporting an occupant thereon, said seat pan having a pair of opposed sides;
at least one belt coupled to said seat body for retaining an occupant in said seat body; and
a belt tensioning mechanism including a rotatable spool coupled to said belt such that said spool can be rotated to wind said belt upon said spool, said spool including a pair of opposed gripping knobs, wherein each knob extends generally outwardly from different ones of said sides of said seat pan.

26. A car seat for a child or infant comprising:
a seat body including a seat back and a seat pan for supporting an occupant thereon, said seat pan having a pair of slots;
a pair of belts coupled to said seat body and being shaped and located to fit at least partially over an occupant to retain said occupant on said seat body; and
a belt tensioning mechanism coupled to said seat body and to each of belts such that said belt tensioning mechanism can be operated to add or decrease tension to said belts, and wherein each belt extends through one of said slots in said seat pan to access said belt tensioning mechanism.

27. A method for adjusting a belt in a car seat for a child or infant comprising the steps of:
providing a car seat including a seat body having a seat back and a seat pan for supporting an occupant thereon, at least one belt coupled to said seat body for retaining an occupant on said seat body, and a belt tensioning mechanism including a rotatable spool coupled to said belt, said tensioning mechanism including a toothed gear and a pawl; and
manually gripping and rotating said spool in a first direction such that said belt is wound about said spool and said pawl engages said gear to block said spool from rotating in a second direction.

28. The method of claim 27 wherein said pawl is movable between an engaged position wherein said pawl contacts said gear and can interact with said gear to selectively block rotation of said spool, and a disengaged position wherein said pawl does not contact said gear, the method farther comprising the step of moving said pawl to said disengaged position and rotating said spool in a second direction opposite to said first direction to unspool said belt from said spool.
